(19) United States
(12) Patent Application Publication
(10) Pub. No.: US 2025/0307712 A1
(43) Pub. Date: Oct. 2, 2025

(54) LARGE LANGUAGE MODEL-BASED THREAT HYPOTHESIS GENERATION

(71) Applicant: Cisco Technology, Inc., San Jose, CA (US)

(72) Inventors: Giovanna Carofiglio, Paris (FR); Luca Muscariello, Paris (FR)

(73) Assignee: Cisco Technology, Inc., San Jose, CA (US)

(21) Appl. No.: 19/095,616

(22) Filed: Mar. 31, 2025

Related U.S. Application Data
(60) Provisional application No. 63/573,278, filed on Apr. 2, 2024.
(60) Provisional application No. 63/573,291, filed on Apr. 2, 2024.

(51) Int. Cl. G06N 20/00; G06N 5/02; H04L 9/40

(52) U.S. Cl. CPC G06N 20/00; G06N 5/02; H04L 63/1433

(57) ABSTRACT

In one implementation, a device generates a knowledge graph that represent a hypothetical attack on a cloud computing environment. The device obtains telemetry data observed from an emulation of the hypothetical attack on the cloud computing environment. The device performs, based on the telemetry data, a validation that the knowledge graph represents an actual attack. The device uses the telemetry data to train a large language model to identify a presence of an attack on the cloud computing environment, based on the validation.

### RELATED APPLICATIONS

This application claims priority to U.S. Prov. Appl. Ser. No. 63/573,278, filed April 2,2024, entitled “LARGE LANGUAGE MODEL-BASED THREAT HYPOTHESIS GENERATION” by Carofiglio, et al. and to U.S. Prov. Appl. Ser. No. 63/573,291, filed April 2,2024, entitled “LARGE LANGUAGE MODEL-BASED THREAT DETECTION” by Carofiglio, et al., the contents of which are incorporated herein by reference.

### TECHNICAL FIELD

The present disclosure relates generally to computer networks and, more particularly, to large language model (LLM)-based threat hypothesis generation.

### BACKGROUND

As cloud computing environments grow in complexity and diversity, they face an escalating wave of sophisticated cyber threats challenging the effectiveness of conventional threat detection mechanisms. Indeed, typical threat detection mechanisms for cloud environments largely rely on predefined threat detection rules that aim to identify specific behaviors or steps indicative of a potential threat or attack. Detection engines then apply these rules in large batches (e.g., tens, hundreds, etc.) to cover as broad a range of threats as possible.

While the threat coverage of these systems is a direct consequence of the number and/or of the diversity of the applied rules, this approach often lacks specificity and adaptability to individual environments. Each cloud environment and/or application deployment may be unique, characterized by its own set of assets, vulnerabilities, associated risks, etc.

A security professional needs to generate threat hypotheses in different tasks of their work both for defensive (blue) security and offensive (red) security. In general, the combination of the two functions has created a more recent methodology called purple teaming, which belongs to defensive security with several techniques taken more traditionally from red team security, like penetration testing. Currently, the generation of threat hypotheses is made via human intervention using a combination of domain knowledge and creativity which are difficult to reproduce.

### BRIEF DESCRIPTION OF THE DRAWINGS

The implementations herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example of a user interfacing with a generative artificial intelligence (AI) model;

FIG. 4 illustrates an example architecture for an AI agent;

FIG. 5 illustrates an example of an architecture for threat detection in cloud native applications;

FIG. 6 illustrates an example of a data collection component of a cloud native detection and response architecture;

FIG. 7 illustrates an example of a data pipeline component of a cloud native detection and response architecture;

FIG. 8 illustrates an example of a cloud application security testing component of a cloud native detection and response architecture;

FIG. 9 illustrates an example of a machine learning pipeline component of a cloud native detection and response architecture;

FIG. 10 illustrates an example of a machine learning operations pipeline of a cloud native detection and response architecture;

FIG. 11 illustrates an example of an architecture for the generation of threat hypotheses using an LLM;

FIG. 12 illustrates an example of architecture for LLM-based threat detection; and;

FIG. 13 illustrates an example simplified procedure for the generation of threat hypotheses using an LLM.

### DESCRIPTION OF EXAMPLE IMPLEMENTATIONS

### Overview

According to one or more implementations of the disclosure, a device generates a knowledge graph that represent a hypothetical attack on a cloud computing environment. The device obtains telemetry data observed from an emulation of the hypothetical attack on the cloud computing environment. The device performs, based on the telemetry data, a validation that the knowledge graph represents an actual attack. The device uses the telemetry data to train a large language model to identify a presence of an attack on the cloud computing environment, based on the validation.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

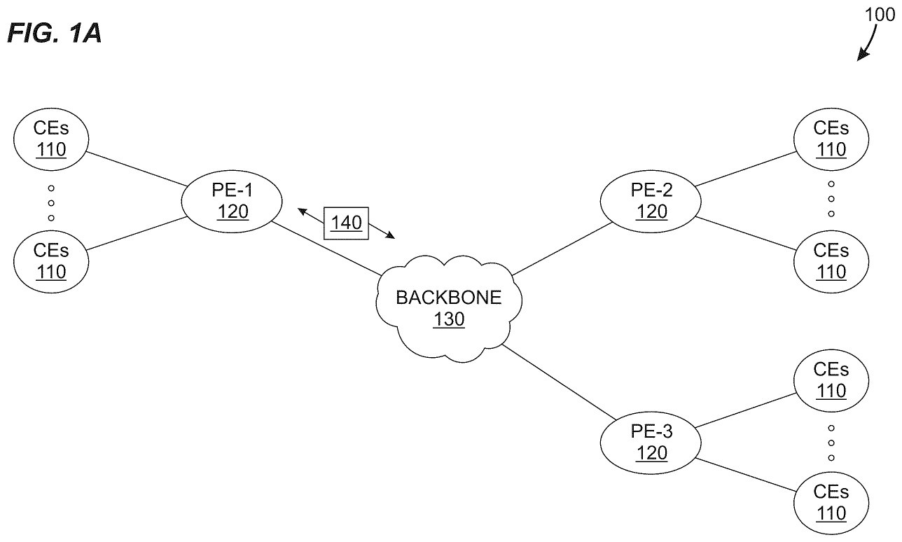

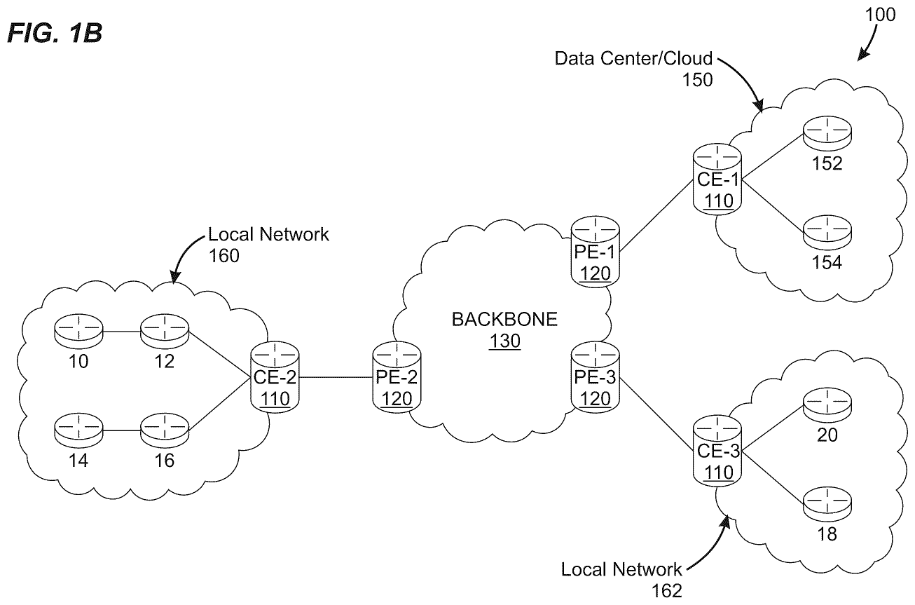

FIG. 1A is a schematic block diagram of an example of a computer network 100 illustratively comprising nodes/devices, such as a plurality of routers/devices interconnected by links or networks, as shown. For example, customer edge (CE) routers (e.g., CE routers 110) may be interconnected with provider edge (PE) routers (e.g., PE routers 120 PE-1, PE-2, and PE-3) in order to communicate across a core network, such as an illustrative network backbone (e.g., network backbone 130). For example, CE routers 110 and PE routers 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router (e.g., CE routers 110) shown in computer network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to computer network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection). Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router connected to PE-2 and a second CE router connected to PE-3.

FIG. 1B illustrates an example of computer network 100 in greater detail, according to various implementations. As shown, network backbone 130 may provide connectivity between devices located in different geographical areas and/or different types of local networks. For example, computer network 100 may comprise local/branch networks (local networks 160, local networks 162, etc.) that include devices/nodes 10-16 and devices/nodes 18-20, respectively, as well as a data center/cloud environment 150 that includes servers 152-154. Notably, local networks 160 and local networks 162 and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, computer network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in computer network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in network backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

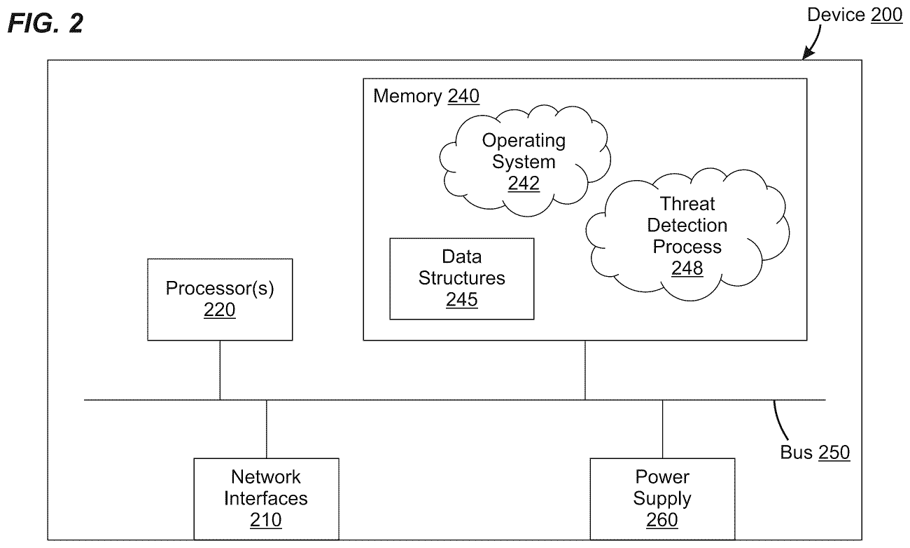

FIG. 2 is a schematic block diagram of an example node/device 200 (e.g., an apparatus) that may be used with one or more implementations described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of computer network 100 (e.g., switches, etc.), or any of the other devices referenced below. The device 200 may also be any other suitable type of device depending upon the type of network architecture in place, such as IoT nodes, etc. Device 200 comprises one or more network interfaces (e.g., network interfaces 210), one or more processors (e.g., processor(s) 220), and a memory 240 interconnected by a system bus 250, and is powered by a power supply 260.

The network interfaces 210 include the mechanical, electrical, and signaling circuitry for communicating data over physical links coupled to the computer network 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software components and/or services may comprise a threat detection process 248 as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, threat detection process 248 may include computer-executable instructions that, when executed by processor(s) 220, cause device 200 to perform the techniques described herein. To do so, in some implementations, threat detection process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), model M can be used very easily to classify new data points. Often, M is a statistical model, and the cost function is inversely proportional to the likelihood of M, given the input data.

In various implementations, threat detection process 248 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that threat detection process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, threat detection process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, generative adversarial networks (GANs), large language models (LLMs) and other foundation models, diffusion models, transformer models, and the like.

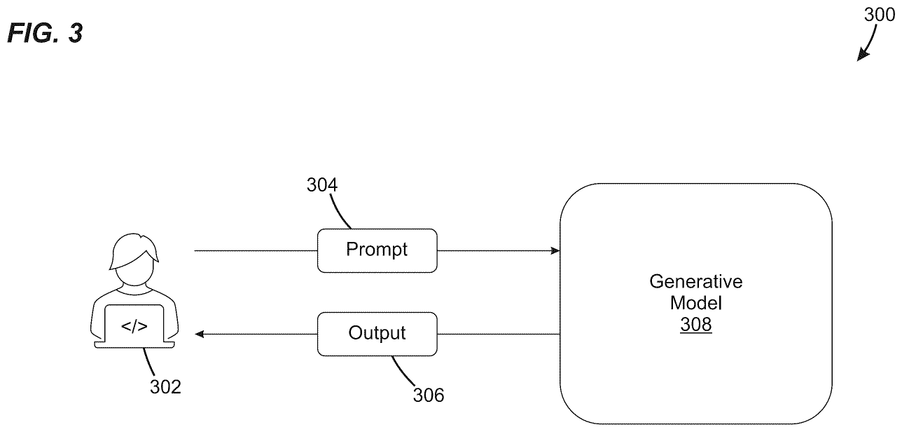

FIG. 3 illustrates an example 300 for interfacing with a generative AI model, in various implementations. In example 300, a user 302 may send a prompt 304 (e.g., a query, a query augmented with additional data, documents, and/or images, etc.) to a generative model 308. The generative model 308 may be configured to process a prompt 304 to generate an output 306 to satisfy the prompt 304.

The generative model 308 may be an AI model configured to apply its trained algorithms to generate a response (e.g., output 306) based on the prompt 304 provided. For instance, in some cases, generative model 308 may take the form of a large language model (LLM) or other foundation model, diffusion-based model, combinations thereof, or the like.

The output 306 may be the result produced by the generative model 308 (e.g., by the application of the generative model 308 to the prompt 304). This output can vary depending on the model's configuration and the task at hand. For example, the output 306 may include one or more of a generated/synthesized image, a text response, a classification, a prediction, etc.

AI agents are also capable of interacting with generative models, such as generative model 308, which may be integrated directly into the agent or accessed via an application programming interface (API). Indeed, the recent breakthroughs in large language models (LLMs), such as GPT-4, as well as other generative models, represent new opportunities across a wide spectrum of industries. More specifically, the ability of these models to follow instructions now allow for interactions with tools (also called plugins) that are able to perform tasks such as searching the web, executing code, etc.

In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

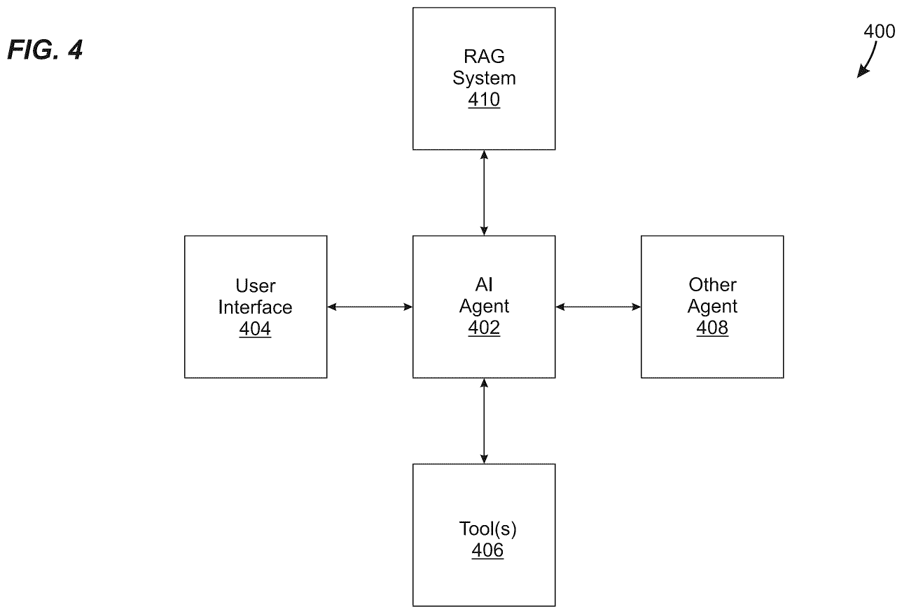

FIG. 4 illustrates an example architecture 400 for an artificial intelligence (AI) agent, according to various implementations. At the core of architecture 400 is AI agent 402. As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device execution AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

In some implementations, AI agent 402 may also interact with, or include, a retrieval augmented generation (RAG) system, such as RAG system 410. In general, RAG systems operate by enhancing a prompt for input to a generative model (e.g., an LLM) with additional context. Typically, underlying a RAG system is a dataset of documents or other information that is in a particular domain.

For instance, consider the case of AI agent 402 generating a prompt that asks its LLM to make an assessment regarding a computer network. In the case of a general LLM, the LLM may not have specialized knowledge regarding the devices in the network (e.g., command line interface commands, information about the topology of the network, etc.). In such a case, RAG system 410 may modify the prompt, prior to input to the LLM, to provide this additional context, thereby improving the quality of the response and avoiding hallucinations. Often, a RAG system stores this contextual information in a vector database for quick retrieval using semantic searching, although other implementations are also possible.

### Cloud Native Threat Detection and Response Architecture

As noted above, threat detection in cloud native application deployments can be challenging. This is largely because of the heterogeneousness of cloud platforms and the current use of static definitions to detect and respond to threats. Despite this, cloud native application security solutions are increasingly called upon to provide coverage across a variety of cloud platforms, Kubernetes clusters, and API resources, while offering prioritization of the most critical risks and vulnerabilities for rapid threat identification and remediation. To address this, the techniques herein introduce a cloud native threat detection and response architecture that is able to detect and respond to threats in (near) real time.

Illustratively, the techniques described herein may be performed by hardware, software, and/or firmware which may include computer executable instructions executed by the processor(s) 220 (or independent processor of network interfaces 210) to perform functions relating to the techniques described herein, such as in conjunction with threat detection process 248.

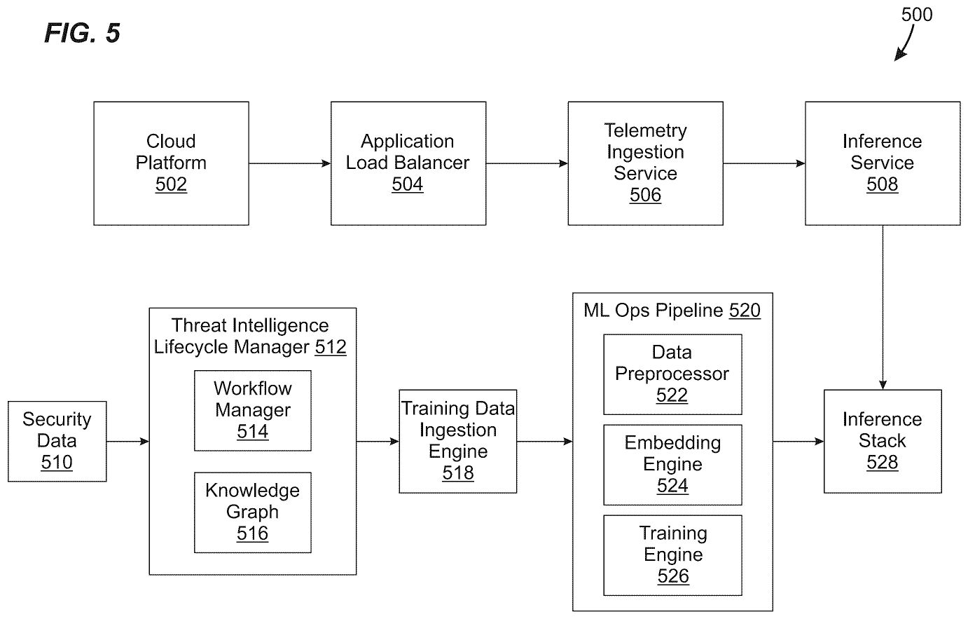

FIG. 5 illustrates an example of an architecture 500 (e.g., a cloud native detection and response architecture) for threat detection in cloud native applications, according to various implementations. According to various implementations, architecture 500 may utilize AI/machine learning to collect and process data from applications and other sources, to manage a threat intelligence lifecycle. As detailed below, this may include the training, evaluating, improving, and/or applying of AI/machine learning models for purposes of threat detection in cloud native applications. In addition, this may include managing data analysis and event notification resulting from the application of the machine learning models.

As shown, assume that there is a cloud platform 502 in which one or more online applications are executed. In some implementations, cloud platform 502 make take the form of a management platform for virtualized or containerized applications, such as Kubernetes. Such implementations allow for an online application to be divided into microservices, which are smaller, independent software components that can be executed in conjunction with one another to serve the application to users via a computer network.

An application load balancer 504 may interact with cloud platform 502 for various purposes, such as coordinating the execution of multiple applications within cloud platform 502. In some instances, application load balancer 504 may also function as a collection point for observability information regarding the execution and performance of the application(s) within cloud platform 502. For instance, cloud platform 502 may execute any number of telemetry collection utilities such as, but not limited to, the Falco daemonset, eBPF, Fluent Bit, Open Cybersecurity Schema Framework (OCSF) data collection utilities, OpenTelemetry (OTel), or the like. Application load balancer 504 or another component may obtain such telemetry/observability data from these utilities via a remote procedure call (RPC), gRPC, HTTP, or the like.

In turn, a telemetry ingestion service 506 may ingest the telemetry/observability data for threat assessment by inference service 508. To do so, telemetry ingestion service 506 may include the corresponding software components needed to ingest the various data generated by the utilities in cloud platform 502 for purposes of observability. For instance, if cloud platform 502 collects OTel data regarding its operation, telemetry ingestion service 506 may include an OTel collector. Similarly, if cloud platform 502 includes the Falco daemonset, telemetry ingestion service 506 may include a notification engine to forward Falco events. Of course, the specific components of telemetry ingestion service 506 may differ, depending on the type(s) of telemetry/observability data that cloud platform 502 collects.

Telemetry ingestion service 506 may further include any number of data streaming utilities, to provide the data that telemetry ingestion service 506 collects in a unified manner. For instance, telemetry ingestion service 506 may leverage Amazon Managed Streaming for Apache Kafka (MSK), to make the telemetry/observability data from cloud platform 502 available for use by inference service 508.

According to various implementations and as detailed further below, architecture 500 may also include an inference service 508 that uses AI/machine learning to assess the telemetry/observability data from cloud platform 502, to detect any potential security threats. As shown, inference service 508 may do so by leveraging an inference stack 528 that uses one or more AI/machine learning models that have been trained to identify threats within a cloud environment, such as cloud platform 502. In one implementation, the mode(s) may also identify one or more corrective measures that

Architecture 500 may also include the training pipeline for the model(s) that underlies inference stack 528. For instance, architecture 500 may include a threat intelligence lifecycle manager 512 that is configured to take as input the security data 510. Generally, security data 510 may include a description of a security threat and may include any related information as well (e.g., remediation actions, etc.). For instance, security data 510 may include OCSF data that is streamed to workflow manager 514 of threat intelligence lifecycle manager 512 via a streaming mechanism such as Apache Kafka or the like.

In some implementations, threat intelligence lifecycle manager 512 may use security data 510 obtained by workflow manager 514 to populate a knowledge graph 516. Here, knowledge graph 516 may take the form of a graph-based data structure with nodes representing objects (e.g., components of cloud platform 502, concepts, etc.) and edges between those nodes representing their relationships. In one implementation, threat intelligence lifecycle manager 512 may store knowledge graph 516 in a graph database such as AarangoDB or the like.

Training data ingestion engine 518 may take as input the security data 510 stored in knowledge graph 516 and provide it to ML Ops pipeline 520 for training of the model(s) used in inference stack 528. To this end, ML Ops pipeline 520 may include a data preprocessor 522 responsible for data preprocessing tasks such as splitting knowledge graph 516 into subgraphs, performing feature engineering, or the like.

In some implementations, ML Ops pipeline 520 may also include an embedding engine 524 that is responsible for converting the data from data preprocessor 522 into vector embeddings. These vector embeddings may represent the (sub) graph formed by data preprocessor 522 into numerical representations. For instance, embedding engine 524 may leverage PyTorch or other suitable mechanism to form the embeddings.

Finally, ML Ops pipeline 520 may include a training engine 526 that uses the embeddings from embedding engine 524 to train the model(s) of inference stack 528. For instance, training engine 526 may use XGBoost (eXtreme Gradient Boosting), which is able to build decision trees over time. In addition, training engine 526 may also be configured to optimize a trained model through techniques such as reinforcement learning,

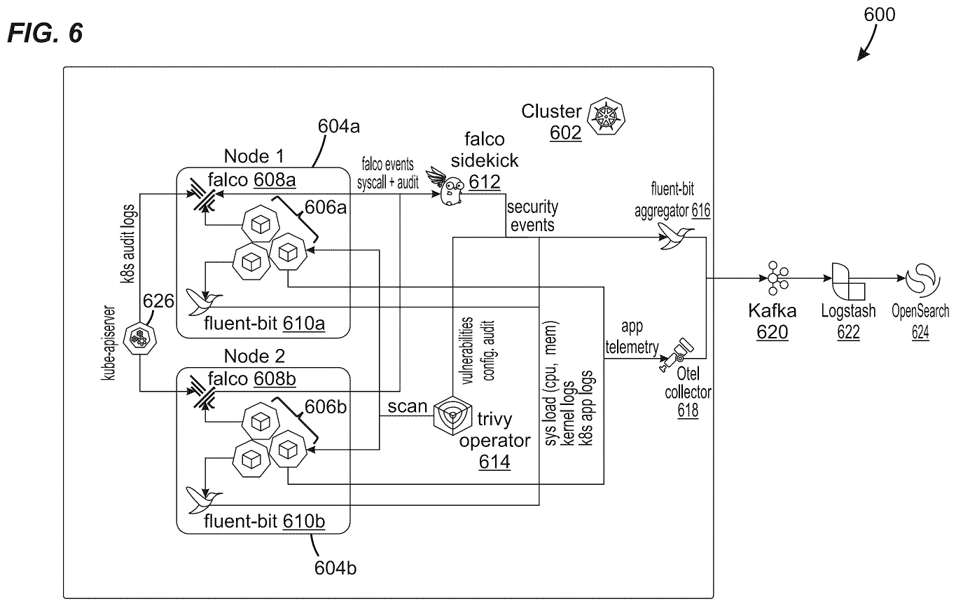

FIG. 6 illustrates an example of a data collection component 600 of a cloud native detection and response architecture, such as architecture 500, according to various implementations. More specifically, FIG. 6 illustrates an example implementation of the various telemetry/observability data collection and reporting functions that could observe and report on the operations of cloud platform 502.

For instance, as shown, consider the case of a Kubernetes cluster 602 within cloud platform 502. Such a cluster may include any number of pods such as pods 606a executed within a first node 604a, pods 606b executed within a second node 604b, etc. Each pod may run a separate container in which a portion of the online application (e.g., a microservice, etc.) may execute.

To monitor the operations and performance within Kubernetes cluster 602, there may be various tools/processes within each node 604. For instance, within first node 604a may be Falco tools 608a, Fluent Bit tools 610a, or the like. Similarly, within second node 604b may be Falco tools 608b, Fluent Bit tools 610b, etc. The Kubernetes API server 626, kube-apiserver, within Kubernetes cluster 602 may provide audit logs to Falco tools 608a and to Falco tools 608b, which may provide the resulting Falco events, system calls, and audit information to a Falco sidekick 612 within Kubernetes cluster 602, so that it can report any observed system events.

Fluent Bit tools 610a and Fluent Bit tools 610b may likewise report their logs (e.g., application logs, kernel logs, etc.), metrics (e.g., system load metric such as CPU metrics, memory metrics, etc.) to a Fluent Bit aggregator 616 within Kubernetes cluster 602.

In some implementations, Kubernetes cluster 602 may also include other observability tools, as well. For instance, OTel collector 618 may collect application telemetry in OTel format for reporting. In addition, Trivy Operator may scan Kubernetes cluster 602 for security issues and report on any detected vulnerabilities, the results of any audits (e.g., configuration audits, etc.), or the like.

Regardless of the specific observability utilities within Kubernetes cluster 602, data collection component 600 may also include utilities to make the telemetry/observability data that they collect available for use by the other components of architecture 500. For instance, data collection component 600 may use a Kafka-based deployment 620 to collect the telemetry/observability data from Kubernetes cluster 602. As would be appreciated, Apache Kafka is an open-source, event streaming platform.

Another potential utility that data collection component 600 could use is a Logstash deployment 622. Generally, Logstash is a server-side data processing pipeline that is able to ingest data from multiple sources, perform data transformations on that data, and make it available.

Finally, data collection component 600 could also make use of an OpenSearch deployment 624, to make its collected telemetry/observability data available within architecture 500. OpenSearch is another open-source platform that supports data searching and analytics. As would be appreciated, deployments 620-624 could also operate in conjunction with one another as Logstash is part of the OpenSearch stack and a Kafka plugin could provide the data for ingestion by the stack.

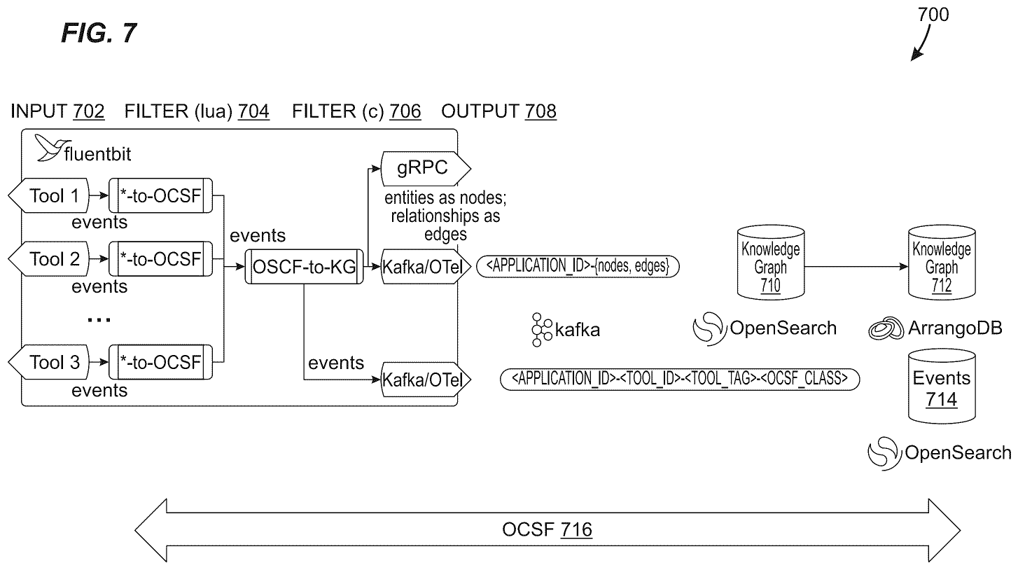

FIG. 7 illustrates an example of a data pipeline component 700 of a cloud native detection and response architecture, such as architecture 500, according to various implementations. For example, data pipeline component 700 may be responsible for providing the security data 510 on which architecture 500 trains its AI model(s). As shown, data pipeline component 700 may operate within an Open Cybersecurity Schema Framework (OCSF) 716.

In some implementations, data pipeline component 700 may leverage a FluentBit deployment having N-number of tools as part of its input 702. In turn, any FluentBit events may undergo a first filter, to convert the events into OCSF format. Data pipeline component 700 may then apply a second filter 706 to provide that OCSF information for storage in a knowledge graph.

At output stage 708, data pipeline component 700 may provide the collected information using any number of suitable connectors. By way of example, data pipeline component 700 may output the collected OCSF events using Kafka, OTel, or the like. Similarly, data pipeline component 700 may use gRPC to output information regarding the entities in the cloud environment and their relationships.

In various implementations, data pipeline component 700 may provide the information about the cloud entities to form a knowledge graph 710 that represents the various entities associated with a given application as nodes and their relationships. For instance, output stage 708 may output messages using the following format:

<APPLICATION_ID>{nodes, edges}

which the output stage 708 could make available through Kafka or another streaming mechanism. Data pipeline component 700 may then construct knowledge graph 710 within OpenSearch and make it available as knowledge graph 712 via a suitable database, such as ArangoDB, which is a graph database.

Similarly, output stage 708 of data pipeline component 700 may output messages regarding the events 714 related to the application using the following format:

<APPLICATION_ID><TOOL_ID><TOOL_TAG><OCSF_CLASS>

In turn, this information could be ingested using OpenSearch or another suitable component.

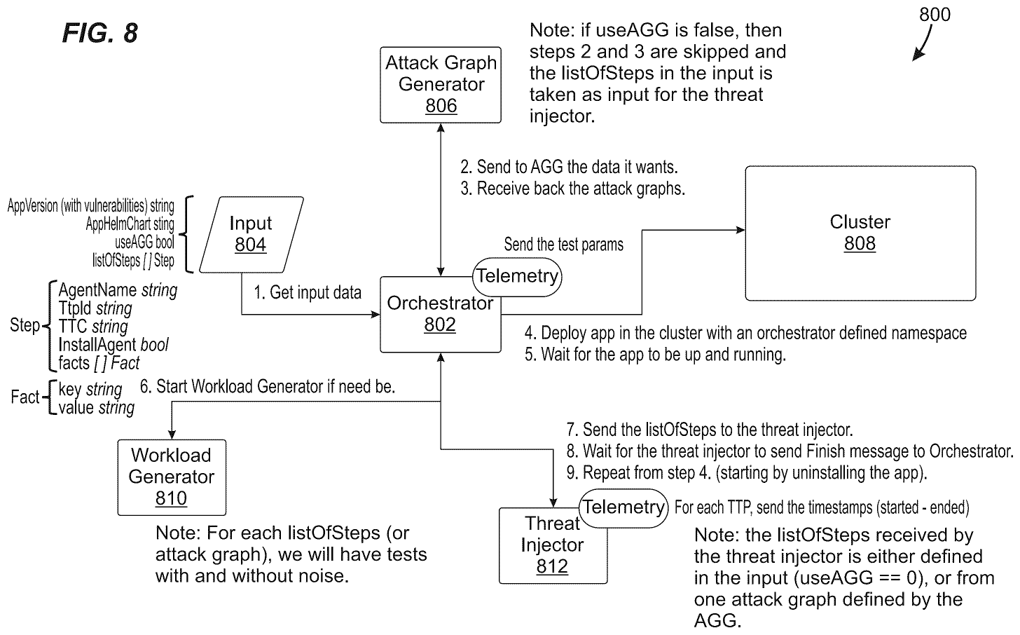

FIG. 8 illustrates an example of a cloud application security testing component 800 of a cloud native detection and response architecture, such as architecture 500, according to various implementations. In some implementations, cloud application security testing component 800 may actively test the application and cloud platform, to identify potential threats and assess how the platform reacts to certain changes.

At the core of cloud application security testing component 800 may be an orchestrator 802 that is responsible for orchestrating the testing of the cloud platform. To this end, orchestrator 802 may take input 804 as input, such as an indication of the application's version, the Helm chart of the application (if hosted in Kubernetes), a flag indicating whether cloud application security testing component 800 should generate an attack graph, a list of steps that orchestrator 802 should take, or the like. In cases in which the list of steps is specified, a given step may indicate the agent's name, Tactics, Techniques, and Procedures (TTP) ID, the install agent, any associated facts (e.g., one or key-value pairs), or the like.

If so requested, orchestrator 802 may then request that attack graph generator 806 generate a corresponding attack graph for the application and cloud environment. Attack graph generator 806 may then return the attack graph(s) to orchestrator 802. Of course, if the request flag, useAGG, in input 804 is false, orchestrator 802 may skip seeking the attack graphs from attack graph generator 806. In some instances, cloud application security testing component 800 may use the generated attack graph(s) in lieu of any explicitly-specified steps in input 804.

In turn, orchestrator 802 may deploy the application in cluster 808 of the cloud environment with an orchestrator-defined namespace. Orchestrator 802 may then wait for the application to be up and running, before initiating its testing. In some case, orchestrator 802 may also call workload generator 810 that is configured to generate workloads for the application to perform. In one implementation, for each of the list of steps or a given attack graph, workload generator 810 may generate tests with and without noise.

Orchestrator 802 may also send the list of steps to threat injector 812. In various instances, the list of steps may be defined via input 804 or, alternatively, by an attack graph from attack graph generator 806. In turn, threat injector 812 may inject the threat into cluster 808, allowing it to collect telemetry regarding how the application and cloud environment reacted to the threat. Threat injector 812 may then return the collected telemetry back to orchestrator 802 and notify it that the threat injection test has finished. Orchestrator 802 may then repeat the above any number of times by reinstalling the application and running another test.

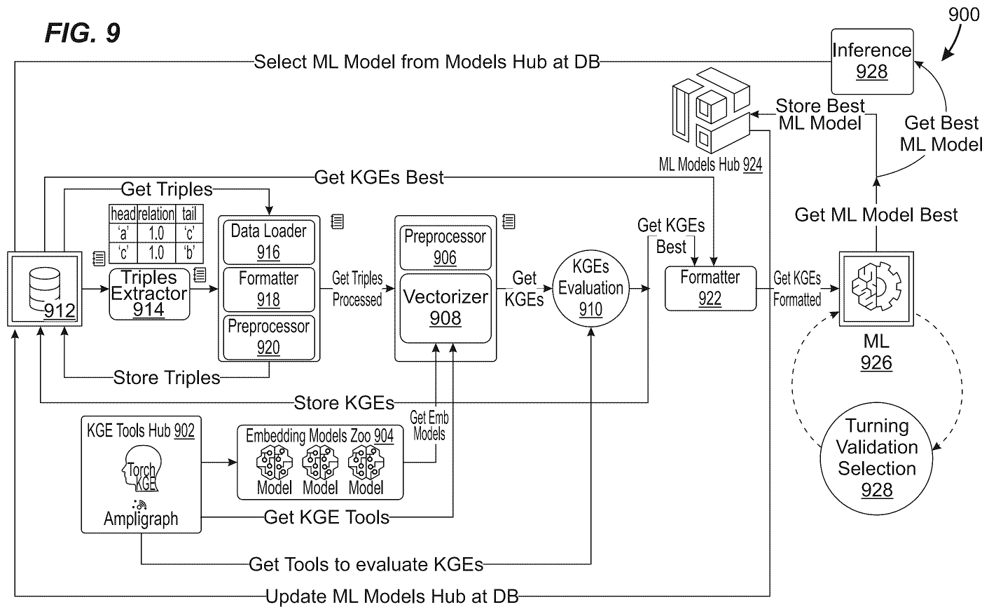

FIG. 9 illustrates an example of a machine learning pipeline component 900 of a cloud native detection and response architecture, such as architecture 500, according to various implementations. Machine learning pipeline component 900 may be utilized to perform training and/or inference of machine learning models to be utilized in detection of threats to cloud native applications. For instance, in the context of architecture 500, inference service 508 may use machine learning pipeline component 900 to make inferences (e.g., threat assessments) using inference stack 528.

As shown, machine learning pipeline component 900 may include a knowledge graph embedding (KGE)-based KGE tools hub 902 that makes available a zoo 904 of embedding models. For instance, KGE tools hub 902 may take the form of an AmpliGraph deployment.

Data processing by machine learning pipeline component 900 may entail a triplet extractor 914 getting embedding triplets from database 912. In turn, data loader 916, formatter 918, and preprocessor 920 may perform their respective functions and send the triplets to preprocessor 906 and vectorizer 908 for further processing. Machine learning pipeline component 900 may also store new triplets in database 912 as they become available.

Machine learning pipeline component 900 may also perform an evaluation 910 of the KGEs, to select the best KGEs. In some instances, formatter 922 may then format the selected KGEs, in order to select the best AI/ML model 926 available for inferencing. In some cases, machine learning pipeline component 900 may also include a model hub 924 in which the best model (e.g., ML model 926) and/or any other models are stored (e.g., within database 912).

When it is time to perform inferencing, machine learning pipeline component 900 may retrieve ML model 926 and use it to make inference 928 regarding the (near-)real-time telemetry/observability data collected from cloud platform 502.

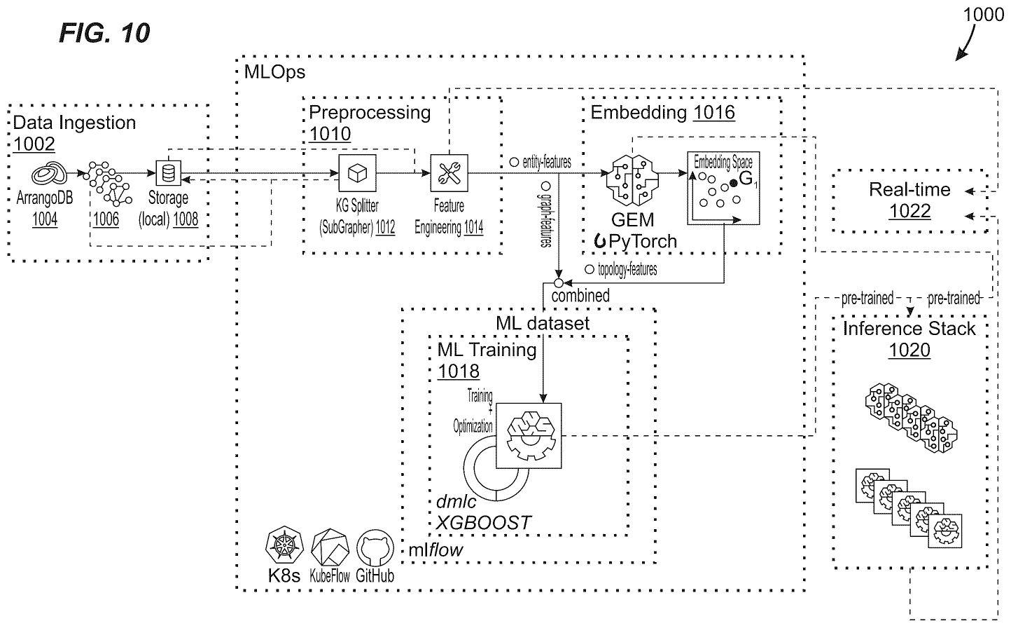

FIG. 10 illustrates an example of a machine learning operations pipeline 1000 of a cloud native detection and response architecture, such as architecture 500, according to various implementations. In general, machine learning operations pipeline 1000 may be responsible for training and updating the AI/machine learning model that the system uses for making inferences (e.g., to implement ML Ops pipeline 520).

As shown, machine learning operations pipeline 1000 may take as input the data captured by data ingestion mechanism 1002 (e.g., data pipeline component 700). Generally, data ingestion mechanism 1002 may capture information regarding the cloud platform and formulate a knowledge graph that represents the entities and their interactions within the cloud platform when the application is executed. In turn, data ingestion mechanism 1002 may turn this information into a knowledge graph 1006 stored in a graph database 1004 within local storage 1008.

A preprocessing component 1010 (e.g., data preprocessor 522 in FIG. 5) may include a knowledge graph splitter 1012 configured to split the knowledge graph into subgraphs. Preprocessing component 1010 may also include a feature engineering engine 1014 configured to perform feature engineering on the subgraphs from knowledge graph splitter 1012 and/or the full knowledge graph from data ingestion mechanism 1002. As would be appreciated, feature engineering entails transforming data into features that an AI/machine learning model can use to make predictions.

In turn, an embedding component 1016 may convert the entitle features into embeddings within an embedding space that represents the various features of the topology of those entities within the cloud environment. Machine learning operations pipeline 1000 may then combine the entity features and the topology features from the graph features into a machine learning dataset.

Machine learning training engine 1018 may then use the combined dataset for purposes of training and optimizing an AI/machine learning model that the system can use within inference stack 1020 to make real-time inferences 1022 regarding the operations of the application within the cloud environment.

### Large Language Model-Based Threat Hypothesis Generation

As noted above, currently, the generation of threat hypotheses is made via human intervention using a combination of domain knowledge and creativity which are difficult to reproduce. Consequently, this manual process requires specialized knowledge, is vulnerable to human error, and its scale is limited by the availability of persons possessing the necessary expertise.

In contrast, the techniques herein introduce a mechanism to automate threat hypothesis generation. This automation is achieved by leveraging an LLM to generate threat hypotheses. These mechanisms may utilize a domain specific language instead of targeting natural language and may leverage LLM architecture designed for natural language processing (NLP) by using knowledge graph structure data instead.

Specifically, according to various implementations, a device generates a knowledge graph that represent a hypothetical attack on a cloud computing environment. The device obtains telemetry data observed from an emulation of the hypothetical attack on the cloud computing environment. The device performs, based on the telemetry data, a validation that the knowledge graph represents an actual attack. The device uses the telemetry data to train a large language model to identify a presence of an attack on the cloud computing environment, based on the validation.

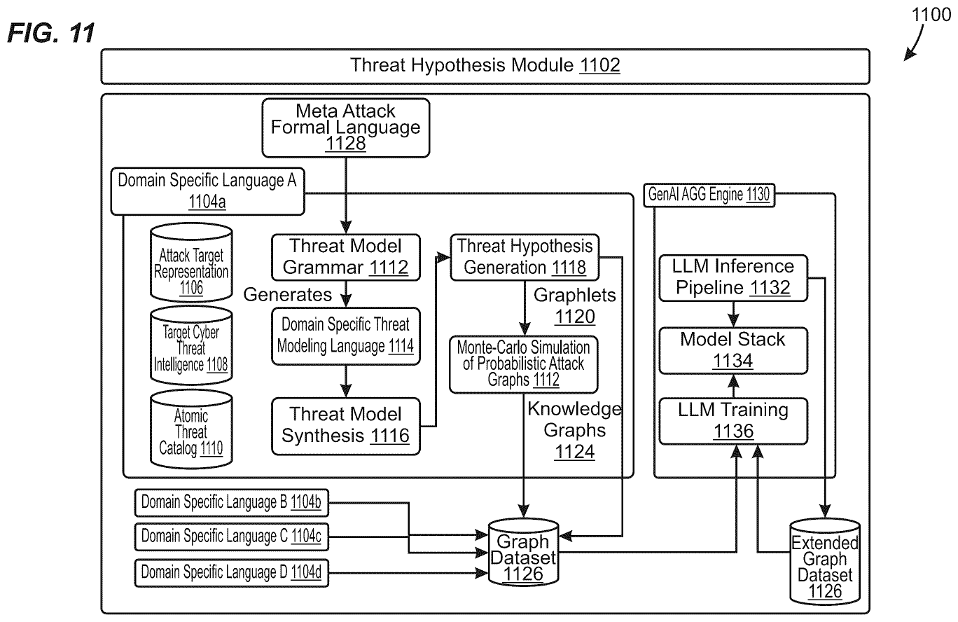

Operationally, FIG. 11 illustrates an example of an architecture 1100 for the generation of threat hypotheses using an LLM, according to various implementations. As shown, architecture 1100 may leverage two primary mechanisms to automate threat hypothesis generation: a domain-specific language generation mechanism and an attack graph generation and analysis mechanism.

More specifically, the first mechanism of architecture 1100 may implement a threat hypothesis module 1102 configured to generate and assess different threat hypotheses regarding the cloud environment (e.g., cloud platform 502). To do so, architecture 1100 may leverage a store 1106 of attack target representations (e.g., the various components, interactions, etc. of the cloud environment), target cyber threat intelligence data 1108 captured from the cloud environment (e.g., the captured telemetry data). Finally, architecture 1100 may also include an atomic threat catalog 1110 which stores information regarding known threats.

As noted, architecture 1100 may make use of a meta language (e.g., to describe the object language and threat model of the target environment) to form domain-specific languages (e.g., the object languages) that describe the assets, events, and adversaries of the specific attack approach. Generally, the meta attack language may describe the domain such as its assets and their relationships that an attacker could utilize (e.g., nodes may take the form of containers, applications, etc.). For instance, architecture 1100 may make use of a meta attack formal language 1128 to form domain-specific languages such as domain specific language 1104a, domain specific language 1104b, domain specific language 1104c, and domain specific language 1104d. Here, a domain-specific language may be considered an expert-driven language to formulate compact description of attacks via formal grammar which can be used to combine security relevant objects together.

The result of a domain specific language may be probabilistic attack graphs which describe a potential attack pattern as well as associated probabilities that such an attack can be performed in practice for a given system target. Architecture 1100 may also use different domain specific languages to generate hypotheses about real world systems (e.g., public cloud, private cloud, enterprise networks, Kubernetes, distributed applications, etc.) from a security point of view. To generate attach graphs, a domain specific language may require real-world data to create a representation of a threat model (e.g., common vulnerabilities and exposures (CVEs), system architecture, workload characteristics, etc.). The initial corpus can be generated using Monte-Carlo simulations or meta-heuristics such as tabu-search, simulated annealing, or genetic algorithms with the overall optimization objective to determine graphs that have a likelihood probability that is large enough. In some instances, the device may use an LLM or other generative AI model to generate hypotheses to validate.

By way of example, for domain specific language 1104a, architecture 1100 may use meta attack formal language 1128 to obtain a threat model grammar 1112 and use it to generate a domain specific threat modeling language 1114. In turn, architecture 1100 may perform threat model synthesis 1116 using domain specific threat modeling language 1114. From this, architecture 1100 may perform threat hypothesis generation 1118, the result of which may be graphlets 1120 (e.g., sub-graphs that represent specific activities in the target environment). In some implementations, architecture 1100 may then perform a Monte-Carlo simulation 1122 of probabilistic attack graphs, resulting in the generation of one or more knowledge graphs 1124. Architecture 1100 may then store the one or more knowledge graphs 1124 in a graph database as graph dataset 1126. As would be appreciated, architecture 1100 may repeat the above for any of its domain specific languages, such as domain specific languages 1104b-1104d.

Here, architecture 1100 may represent attack graphs in the form of the one or more knowledge graphs 1124, which may also be of different sizes. Once generated, architecture 1100 may then use the one or more knowledge graphs 1124 as input to an LLM or other generative AI model for assessment. For instance, architecture 1100 may feed the LLM using time-varying replicas of the same attack graphs with the objective to create long-range dependent memory of the attack in the LLM. During the training phase, a trade-off between the space-time cost of feeding the LLM may be determined (e.g., LRD time window size and spatial size of the attack graph).

For instance, as shown, architecture 1100 may provide one or more knowledge graphs 1124 to a generative AI engine 1130 for assessment. Here, architecture 1100 may perform LLM training 1136 to train its model. Then, it may assemble a model stack 1134 and use an LLM inference pipeline 1132 to assess the various threat hypotheses., resulting in an extended graph dataset 1138.

### Large Language Model-Based Threat Detection

Also as noted above, the conventional approach to threat detection relies on human analysis of suspicious events that is not currently able to be effectively automated. Current automation techniques are based on graph queries in the best case assuming the telemetry data and suspicious activity is structured already as knowledge graphs to perform efficient graph traversal operations to search for information-of-compromise and match that to forensic data. This approach suffers from scalability as real-time data must be queried online. Computing telemetry data to formally verify a threat hypothesis is not currently utilized. While LLMs have been used to correlate well known system vulnerabilities to generate attack paths, they have not been utilized to perform threat detection tasks.

In contrast, the techniques herein introduce a mechanism for LLM-based threat detection. The LLM-based approach to threat detection may facilitate detecting patterns and/or making predictions that some data may be part of an actual ongoing attack in real time, even when only partially monitored.

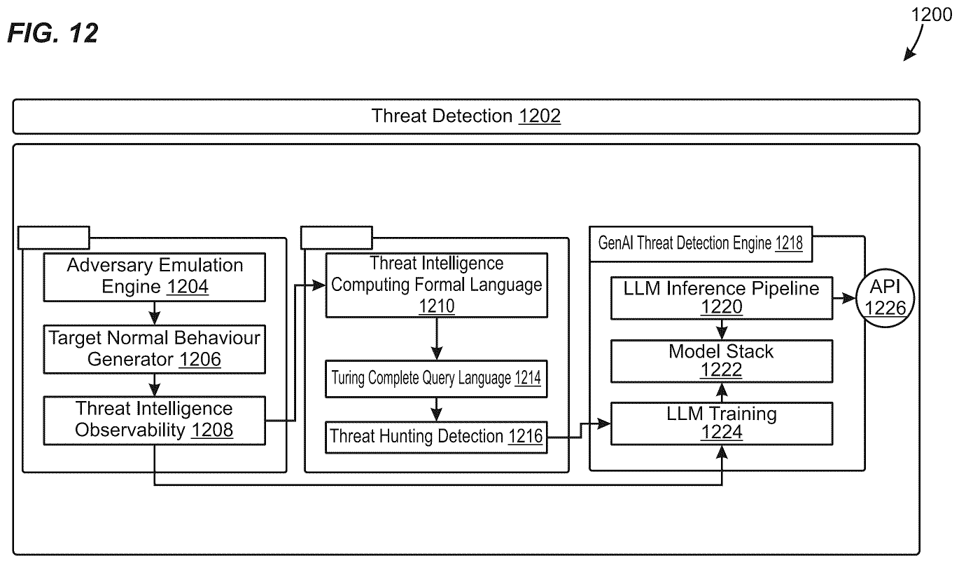

FIG. 12 illustrates an example of architecture 1200 for LLM-based threat detection. In various implementations, architecture 1200 may implement a threat detection mechanism 1202 that uses an LLM to detect threats in an environment, such as cloud platform 502.

As shown, architecture 1200 may include an adversary emulation engine 1204 configured to emulate a malicious entity initiating an attack against the target environment. Architecture 1200 may also include a target normal behavior generator 1206 configured to generate the normal behaviors of the target environment. Finally, architecture 1200 may collect the threat intelligence observability data 1208 (e.g., telemetry from the target environment, such as cloud platform 502, and/or the emulated system).

In various implementations, architecture 1200 may train an LLM or other generative AI model with telemetry data that is encoded as knowledge graphs. In this case, the input data may not be a natural language, but actual data collected from an emulated system, as described above. The specific tasks for the LLM may be to analyze input data and determine whether cybersecurity attacks are present and/or provide a proof of that by providing its forensics.

For instance, architecture 1200 may use a threat intelligence computing formal language 1210 such as meta attack formal language 1128 described previously. In turn, architecture 1200 may use meta attack formal language 1128 to generate knowledge graphs 1212. In some instances, knowledge graphs 1212 may take the form of the one or more knowledge graphs 1124 in FIG. 11. Architecture 1200 may store knowledge graphs 1212 in a graph database, thereby allowing for the system to retrieve information from the knowledge graphs using a Turing complete query language 1214, to perform threat hunting detection 1216. Such a task may allow it to answer to threat hypothesis deterministically and/or in a scalable way without human intervention as threat hunting is automated.

In various implementations, architecture 1200 may also include a generative AI threat detection engine 1218 that may leverage a LLM or other suitable generative AI model. The usage of an LLM provides architecture 1200 the ability to record long-range dependency in the data both in space and in time related to malicious activities. During the training phase 1224, the identification of malicious activities can be made on large knowledge graphs and on subsets of it. The identifications can also be made on time varying replicas of the same malicious activity, assuming that the data is sequentially collected, like in a real time system. Once its model is trained, generative AI threat detection engine 1218 may then use its model stack 1222 and LLM inference pipeline 1220 to perform threat detection.

In some instances, the telemetry data that is used to feed the LLM of generative AI threat detection engine 1218 may not constitute a domain-specific language nor a natural language, but more specifically graph-data representing system, network, or application activity. The fact that the data is transformed in knowledge graphs may create a language without grammar that the LLM can encode and decode. The formal language used in this mechanism may be used exclusively to label data via domain knowledge and feed a notion of true/false that is mapped in the threat detection output of the model. The power of the large model may reside in its ability to detect patterns or make prediction that some data may be part of an actual ongoing attack in real-time that is only partially monitored.

As shown, architecture 1200 may also provide an API 1226 allowing the system to provide indications of detected threats. For instance, API 1226 may provide threat detection information to a user interface to allow an administrator to review the threat. In other instances, API 1226 provides the threat to security mechanism that initiates corrective measures.

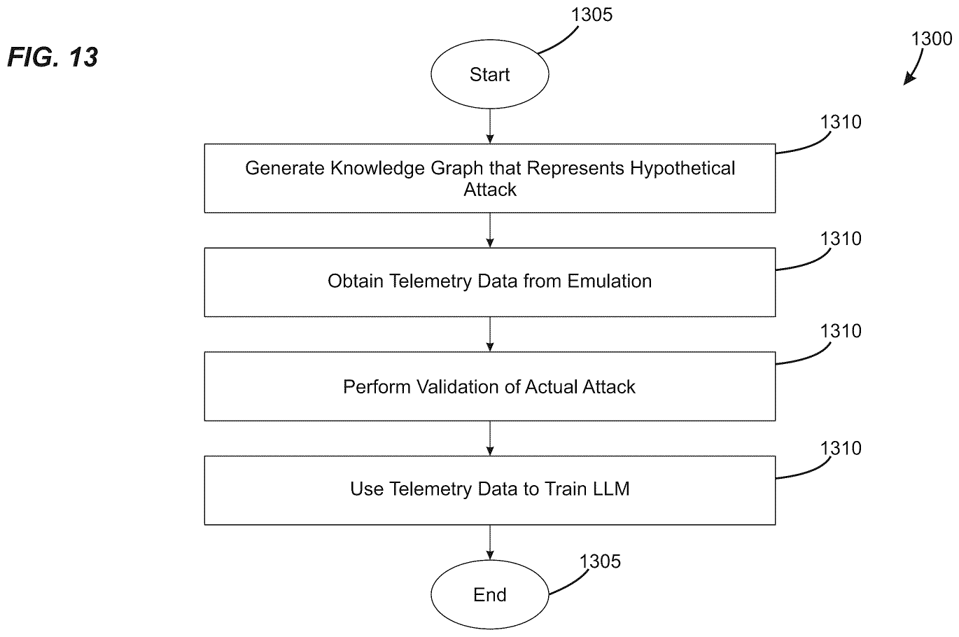

FIG. 13 illustrates an example procedure 1300 (e.g., a method) for detecting threats to a cloud application using a knowledge graph, in accordance with one or more embodiments described herein. For example, a non-generic, specifically configured device (e.g., device 200), such as a router, firewall, controller for a network (e.g., an SDN controller or other device in communication therewith), server, or the like, may perform procedure 1300 by executing stored instructions (e.g., threat detection process 248). The procedure 1300 may start at step 1305, and continues to step 1310, where, as described in greater detail above, the device may generate a knowledge graph that represent a hypothetical attack on a cloud computing environment. In some implementations, the device uses a meta attack formal language that describes the hypothetical attack and a domain specific language that describes the cloud computing environment to generate the knowledge graph. In one implementation, the device performs a Mote-Carlo simulation to generate the knowledge graph. In a further implementation, the device forms graphlets that represent actions within the cloud computing environment on which the device generates the knowledge graph. In one implementation, the knowledge graph indicates a probability of the hypothetical attack on the cloud computing environment. In some implementations, the cloud computing environment is a Kubernetes environment.

At step 1315, as detailed above, the device may obtain telemetry data observed from an emulation of the hypothetical attack on the cloud computing environment. In various implementations, the device obtains the telemetry data from at least one of: a Falco daemonset, eBPF, a Fluent Bit data exporter, an Open Cybersecurity Schema Framework (OCSF) data collection utility, or an OpenTelemetry (OTel) collector.

At step 1320, the device may perform, based on the telemetry data, a validation that the knowledge graph represents an actual attack, as described in greater detail above.

At step 1325, as detailed above, the device may use the telemetry data to train a large language model to identify a presence of an attack on the cloud computing environment, based on the validation. In various implementations, the device provides the large language model for use to detect potential threats to the cloud computing environment. In some implementations, the device trains the large language model in part using time-varying replicas of the knowledge graph. In further implementations, the device trains the large language model in part using subsets of the knowledge graph as training data.

Procedure 1300 then ends at step 1330.

It should be noted that while certain steps within procedure 1300 may be optional as described above, the steps shown in FIG. 13 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

It should be noted that while certain steps as described above may be optional, these steps are merely examples for illustration, and certain other steps may be included or excluded as desired. Further, while in some instances the steps are described in relation to a particular ordering, this ordering is merely illustrative, and any suitable arrangement of the steps may be utilized without departing from the scope of the implementations herein.

While there have been shown and described illustrative implementations that provide for LLM-based threat hypothesis generation and for LLM-based threat detection, it is to be understood that various other adaptations and modifications may be made within the spirit and scope of the implementations herein. For example, while certain implementations are described herein with respect to using certain elements, modules, components, architectures, etc. for the purposes of LLM-based threat hypothesis generation, the elements, modules, components, architectures, etc. are not limited as such and may be used for other functions, in other arrangements, in other functional distributions, in other implementations, etc.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as tangible, non-transitory, computer-readable medium having computer-executable instructions stored thereon that, when executed by a processor on a computer, cause the computer to perform a method. For example, the components and/or elements may be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method comprising:
generating, by a device, a knowledge graph that represent a hypothetical attack on a cloud computing environment;
obtaining, by the device, telemetry data observed from an emulation of the hypothetical attack on the cloud computing environment;
performing, by the device and based on the telemetry data, a validation that the knowledge graph represents an actual attack; and
using, by the device, the telemetry data to train a large language model to identify a presence of an attack on the cloud computing environment, based on the validation.

2. The method as in claim 1, further comprising:
providing the large language model for use to detect potential threats to the cloud computing environment.

3. The method as in claim 1, wherein the device trains the large language model in part using time-varying replicas of the knowledge graph.

4. The method as in claim 1, wherein the device trains the large language model in part using subsets of the knowledge graph as training data.

5. The method as in claim 1, wherein the device uses a meta attack formal language that describes the hypothetical attack and a domain specific language that describes the cloud computing environment to generate the knowledge graph.

6. The method as in claim 5, wherein the device performs a Mote-Carlo simulation to generate the knowledge graph.

7. The method as in claim 5, wherein the device forms graphlets that represent actions within the cloud computing environment on which the device generates the knowledge graph.

8. The method as in claim 1, wherein the knowledge graph indicates a probability of the hypothetical attack on the cloud computing environment.

9. The method as in claim 1, wherein the cloud computing environment is a Kubernetes environment.

10. The method as in claim 1, wherein the device obtains the telemetry data from at least one of: a Falco daemonset, eBPF, a Fluent Bit data exporter, an Open Cybersecurity Schema Framework (OCSF) data collection utility, or an OpenTelemetry (OTel) collector.

11. An apparatus, comprising:
one or more network interfaces;
a processor coupled to the one or more network interfaces and configured to execute one or more processes; and
a memory configured to store a process that is executable by the processor, the process when executed configured to:
generate a knowledge graph that represent a hypothetical attack on a cloud computing environment;
obtain telemetry data observed from an emulation of the hypothetical attack on the cloud computing environment;
perform, based on the telemetry data, a validation that the knowledge graph represents an actual attack; and
use the telemetry data to train a large language model to identify a presence of an attack on the cloud computing environment, based on the validation.

12. The apparatus as in claim 11, wherein the process when executed is further configured to:
provide the large language model for use to detect potential threats to the cloud computing environment.

13. The apparatus as in claim 11, wherein the apparatus trains the large language model in part using time-varying replicas of the knowledge graph.

14. The apparatus as in claim 11, wherein the apparatus trains the large language model in part using subsets of the knowledge graph as training data.

15. The apparatus as in claim 11, wherein the apparatus uses a meta attack formal language that describes the hypothetical attack and a domain specific language that describes the cloud computing environment to generate the knowledge graph.

16. The apparatus as in claim 15, wherein the apparatus performs a Mote-Carlo simulation to generate the knowledge graph.

17. The apparatus as in claim 15, wherein the apparatus forms graphlets that represent actions within the cloud computing environment on which the apparatus generates the knowledge graph.

18. The apparatus as in claim 11, wherein the knowledge graph indicates a probability of the hypothetical attack on the cloud computing environment.

19. The apparatus as in claim 11, wherein the cloud computing environment is a Kubernetes environment.

20. A tangible, non-transitory, computer-readable medium storing program instructions that cause a device to execute a process comprising:
generating, by the device, a knowledge graph that represent a hypothetical attack on a cloud computing environment;
obtaining, by the device, telemetry data observed from an emulation of the hypothetical attack on the cloud computing environment;
performing, by the device and based on the telemetry data, a validation that the knowledge graph represents an actual attack; and
using, by the device, the telemetry data to train a large language model to identify a presence of an attack on the cloud computing environment, based on the validation.
